(19) United States
(12) Patent Application Publication
(10) Pub. No.: US 2011/0263461 A1
(43) Pub. Date: Oct. 27, 2011

(54) METHODS AND DEVICES FOR COLLECTING SAMPLES IN A HIGH THROUGHPUT FORMAT

(76) Inventors: Kumar KASTURY, San Jose, CA (US); Aparna PALAPARTHI, San Jose, CA (US)

(21) Appl. No.: 13/092,337

(22) Filed: Apr. 22, 2011

Related U.S. Application Data
(60) Provisional application No. 61/327,577, filed on Apr. 23, 2010.

(51) Int. Cl. C40B 50/00; C40B 60/14

(52) U.S. Cl. 506/23; 506/40

(57) ABSTRACT

The present invention is directed methods for collecting and storing samples compatible for high throughput automation. The present invention is also directed to a device comprising: (a) a plate containing multiple wells, and (b) multiple rubber covers; wherein each rubber cover is (i) an integral part of the device, (ii) is on top of each well and individually seal each well, and (iii) has a pierceable area in the center of the cover. The device is suitable for collecting, storing, transporting, and tracking samples compatible for high throughput downstream automated processing.

This application claims the benefit of U.S. Provisional Application No. 61/327,577, filed Apr. 23, 2010, which is incorporated herein by reference in its entirety.

### TECHNICAL FIELD

This invention relates to methods and devices for collecting, tracking, storing, transporting, and preparing samples to be analyzed by a high throughput automation format.

### BACKGROUND OF THE INVENTION

Many high-volume routine laboratory assays supply important diagnostic information. Providing accurate results in a fast turn-around time and cost effective manner is not only important from a diagnostic standpoint but can also prevent frustration inherent when the effort of collecting and submitting samples does not yield interpretable results. Examples of applications where thousands of samples need to be processed quickly, efficiently and cost effectively are blood screening for pathogens and animal testing in the farm to eradicate sick and infectious animals.

The risk of transfusion-transmitted hepatitis B virus (TTHBV) has been steadily reduced through the use of volunteer donors, enhanced donor questioning, and increasingly sensitive hepatitis B surface antigen (HBsAg) tests. Nevertheless, the risk of TTHBV in most countries is higher than the risk of either human immunodeficiency virus-1 (HIV-1) or hepatitis C virus (HCV); the main reason being viremia during the window period preceding antibody or antigen detection by enzyme immunoassays. Immunosilent-infected individuals and carriers of distant viral variants also play an unquantifiable role. Multiple techniques, e.g. reverse transcription polymerase chain reaction (RT-PCR), PCR, ligase-chain reaction, nucleic acid sequence-based amplification (NASBA) and transcription-mediated amplification (TMA) have been developed to amplify and detect viral genomes as single or multiplex assays. Equipment providing various degrees of automation has been adapted to these techniques. Two main approaches (plasma pool and single-donation testing) are used when applying nucleic acid amplification techniques (NAT) for blood screening. Pool testing presents the advantage of lower cost and readily available equipment although it is prone to false negative and positive reactions. The time required to identify infected donations is incompatible with blood component release, and may lead to product waste. Single-unit testing, although appealing, is not yet fully automated and potentially costly unless a systematic multiplex approach is taken. Although technically feasible, NAT applied to the blood supply needs to be clinically evaluated and its cost efficiency assessed in the general public health context. Pool NAT is currently implemented in continental Europe and the USA.

High-throughput screening (HTS) is a method often used in drug discovery and in pathogen screening. Using robotics, data processing and control software, liquid handling devices, and sensitive detectors, HTS allows a researcher to quickly conduct hundreds, thousands, and millions of biochemical, genetic or pharmacological tests. Through this process one can rapidly identify active compounds, antibodies or genes which modulate a particular biomolecular pathway. The results of these experiments provide starting points for drug design and for understanding the interaction or role of a particular biochemical process in biology. In essence, HTS uses automation to run an assay, or screen a library of candidate compounds against a target. Automation is an important element in HTS's usefulness. Typically, an integrated robot system consisting of one or more robots transports assay-microplates from station to station for sample and reagent addition, mixing, incubation, and finally readout or detection. An HTS system can usually prepare, incubate, and analyze many plates simultaneously, further speeding the data-collection process.

Currently the samples are collected in individual tubes or vials in the field and then sent to the laboratory for analysis. The tubes are bulky and they are not suitable for automation. The caps of the tubes need to be removed, and the samples transferred to multi-well plates which are suitable for automated processing. When the samples are in the numbers of thousands, the efforts of collecting, processing, and tracking samples are tedious, time-consuming, and prone to errors.

There exists a need for improved methods and devices for collecting, storing, transporting, and tracking samples. The improved methods and devices should be efficient, cost-effective, and accurate. The improved methods and devices should avoid sample contamination from the field and cross-contamination from the other samples.

### BRIEF DESCRIPTION OF THE FIGURES

FIG. 1 illustrates one embodiment of the present invention for collecting samples into a multi-well plate.

FIGS. 2A and 2B illustrate another embodiment of the present invention for collecting samples into a multi-well plate.

FIG. 3 illustrates a top view of the device.

FIG. 4 illustrates a side view of the device.

### DETAILED DESCRIPTION OF THE INVENTION

The present invention is directed to methods and devices for collecting, storing, transporting, tracking, and preparing samples. The method and devices are suitable for high throughput assays where hundreds, thousands, and millions of samples are analyzed for specific activities. The methods and devices are compatible with automation for the downstream sample analysis.

### Methods for Collecting and Storing Liquid Samples

The present invention is directed to a method for collecting and storing liquid samples compatible for high throughput automation. Liquid samples include, but are not limited to, biological samples (such whole blood, plasma, serum, urine, saliva, sweat, teats, spinal fluid, semen, organ aspirate, and amniotic fluid), beverages (such as milk and drinks), fermentation samples, bioprocessing samples, culture medium, and environmental samples (such as water).

The method comprises the steps of: (a) providing a plate containing multiple wells, each of the multiple wells is top-sealed by a rubber material; (b) collecting a first liquid sample into an applicator; (c) piercing the applicator through the rubber material; (d) dispensing the first liquid sample from the applicator into a first well; and (e) repeating the steps (b)-(d) multiple times. The steps (b)-(d) are repeated until the wells are filled with the samples. Optionally, each plate will leave one or several wells (e.g. 1, 2, or 3 wells) unfilled as control blanks. Preferably, each plate will leave one well unfilled as a control blank.

The present method preferably comprises a step (f) after step (e) by placing an adhesive film on top of the plate and sealing the plate. The adhesive film is a film (such as plastic, aluminum, or paper) with an adhesive on one side. The adhesive adheres to the plate and the film serves as a top cover of the plate.

The steps (a)-(f) can be repeated multiple times using a new plate until all the samples are collected.

When collecting samples in the field, for example, collecting animal blood samples in a farm, it is useful to have a bottom plastic cover for the multi-well plate to sit on. The bottom cover serves as the cover for the bottom of the plate such that the wells of the plate do not contact an unclean surface, and thus the bottom cover prevents the multi-well plate from carrying contamination. The bottom covers and the top adhesive films are removed before the multi-well plates are stacked for robotic handling during the testing of samples. Because the multi-well plates contact each other during robotic handling, it is important that the bottom of the plate does not carry contamination. The bottom cover preferably snaps onto the multi-well plate during sample collection, storing, and transportation, and is removed (snapped out) for automation.

Plates suitable for the method are those containing 24, 48, 96, or 384 wells that are compatible with automation; preferably conform to SBS (Society for Biomolecular Screening) foot print. The wells preferably have a conical shape, a thin wall, and are thermally conductive. Plates can be made of plastic or metal. Preferred plastic plates are made of polypropylene and polycarbonate, which are thermoductive. Preferred metal plates are made of aluminum, nickel, and copper with aluminum being the most preferred. Metal plates optionally can be coated with hydrophobic materials such as Teflon, silane, Paralyne, etc., inside and/or outside. Metal plates can also optionally be coated with hydrophilic materials inside and/outside. Suitable plates, by way of illustration, include 96 well PCR plates (semi skirted), 96 well PCR plates (full-skirted), both from E&K; 0.2 mL thin-wall 8 strip PCR tubes, 24-well PCR Microplates, 32-well PCR Microplates, and 48-well PCR Microplates, from Axygen. Each plate optionally has a bar code or a RFID (Radio Frequency Identification) tag for tracking purpose.

The rubber material used to seal the well can be natural rubber or synthetic rubber. Natural rubber is an elastomer (elastic hydrocarbon polymer). The purified form of natural rubber is polyisoprene, which can also be produced synthetically. Synthetic rubber can be made from the polymerization of a variety of monomers including isoprene (2-methyl-1,3-butadiene), 1,3-butadiene, chloroprene (2-chloro-1,3-butadiene), and isobutylene (methylpropene) with a small percentage of isoprene for cross-linking.

Preferred rubber materials suitable for the present invention include silicone rubber, bromo isobutylene isoprene, polybutadiene, polyisoprene, polyisobutylene, polyurethane, and halogenated butyl rubber. Silicone rubber, by definition, is a rubber-like material composed of silicones, which are mixed inorganic and organic polymers with the chemical formula (R₂SiO)ₙ. Silicone rubber is a preferred material for this invention. Silicone rubber for example includes fluoro silicone, methyl vinyl silicone and polysiloxane. Other rubber-like materials such as polydimethyl fumarate (PDMF), polydiethyl fumarate (PDEF), polydiisopropyl fumarate (PUTT), polydicyclohexyl fumarate (PDCHF), are also suitable for the present invention.

The rubber cover on top of each well can be indented into the well (cup-like) or it can be flat and above the well. The rubber cover can be individually on top of each well with plastic material in between, or it can be one single piece covering the entire plate. The rubber cover has a pierceable area (a line, triangle, circle, or square) in the center of the well. The pierceable area is thinner than other areas of the rubber seal, and can be pierced easily. After puncture, the pierceable area is re-sealed due to the elastic nature of the rubber material. The rubber cover prevents any leakage of the liquid sample during the transportation of the samples to the laboratory for testing. The rubber cover, also prevents any contamination due to aerosol in the field while collecting samples by not exposing the wells to the environment. In addition, the rubber cover prevents any cross contamination of samples between the wells while dispensing sample into a neighboring well.

The applicator is a disposable single-use tubular object that has a pointed or flat end. The end contacts a liquid sample and draws the liquid into the tube. A preferred applicator is a tube with a capillary shape such as a capillary. The capillary-shape tube can be made of a metal, a plastic (e.g., a disposable pipette tip), or glass (e.g. a Pasteur pipette). Another preferred applicator is a syringe with a needle. The applicator needs to be strong and sturdy enough to pierce through the rubber material to deposit the sample inside the well. The inside of the tube is optionally coated with an anti-coagulant such as heparin (ammonium heparin or sodium heparin) or EDTA (ethylenediaminetetraacetic acid), or a preservative. Preferably the applicator is sterile.

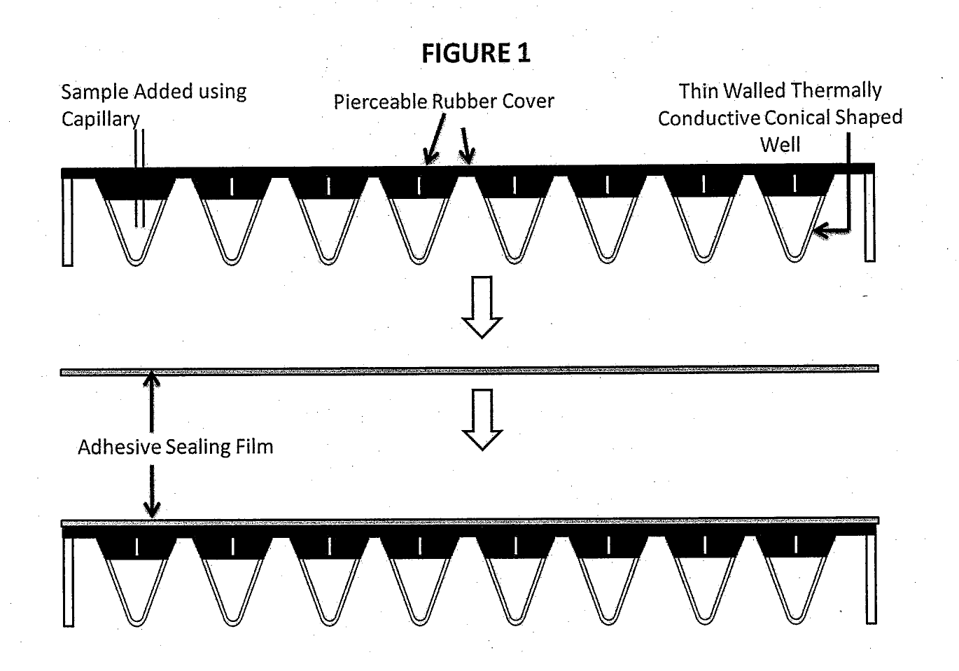

FIG. 1 illustrates one embodiment of the method, in which the rubber cover is a single piece sitting on top of the entire plate. A capillary containing the sample pierces through the rubber cover and dispenses the sample into a conductive conical shaped well. After all the samples are dispensed into the wells, an adhesive film seals the plate.

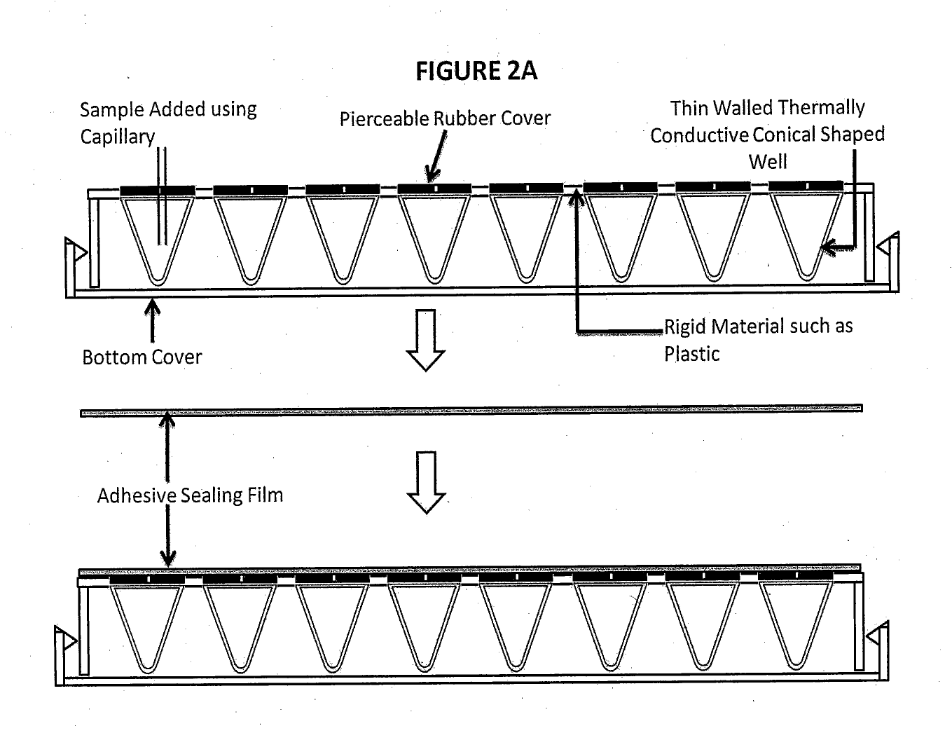

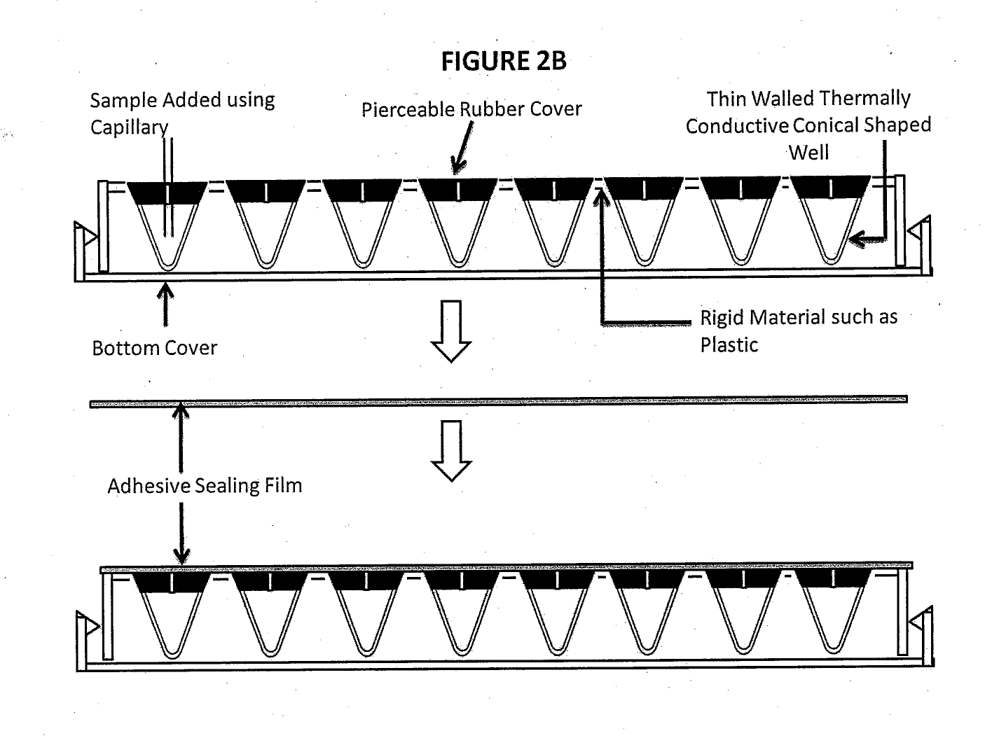

FIGS. 2A and 2B illustrate another embodiment of the method, in which the rubber cover is an integral part of the plate. Each rubber cover is individually on top of each well and there is a plastic material in between the rubber covers. The multi-well plate sits on top of a bottom cover. A capillary containing the sample pierces through the rubber cover and dispenses the sample into a conductive conical shaped well. After all the samples are dispensed into the wells, an adhesive film seals the plate. In FIG. 2A, the rubber cover is above each well. In FIG. 2B, the rubber cover is indented into each well.

The sample dispensing is preferably performed when the plate temperature is cold (e.g. 2-8°). The transition from warm temperature of the liquid sample in the applicator to cold temperature of the well creates partial vacuum and makes the sample dispensing from the capillary into the well easier. If the ambient temperature is warm, the plate can be put on ice, or kept in a refrigerator.

The volume of the liquid sample dispensed into each well is typically 20-50 μL, and is preferably 20-30 μL. The liquid sample is preferably dispensed into a well that can hold a volume of 200 μL.

### Methods for Collecting and Storing Non-Liquid Samples

The present invention is also directed to a method for collecting and storing non-liquid samples compatible for high throughput automation. Non-liquid samples (e.g. solid or semi-solid samples) suitable for the present method include, but are not limited to, fecal samples, animal or human tissues (fresh, frozen, or formalin fixed paraffin embedded), cells, hairs, nails, buccal swabs, and soils.

The method comprises the steps of: (a) providing a plate containing multiple wells, (b) collecting a first non-liquid sample with a first applicator, (c) dispensing the first sample into a first well and discarding the first applicator, and (d) repeating the steps (b)-(c) multiple times. The steps (b)-(c) are repeated until the wells are filled with the samples. Optionally, each plate will leave one or several wells (e.g. 1, 2, or 3 wells) unfilled as control blanks. Preferably, each plate will leave one well unfilled as a control blank.

The present method optionally comprises steps of providing a box having a lid, placing the plate in the box during the steps (b)-(c), opening the lid during the dispensing step (c), and closing the lid during the collecting step (b).

The present method preferably comprises a step (e) after step (d) by placing an adhesive film on top of the plate and sealing the plate. The adhesive film is a film (such as plastic, aluminum, or paper) with an adhesive on one side. The adhesive adheres to the plate and the film serves as a top cover of the plate.

The steps (a)-(e) can be repeated multiple times with a new plate until all the samples are collected.

Plates suitable for the methods for collecting non-liquid samples are the same as those described for the liquid samples.

Any applicators suitable for collecting non-liquid samples and dispensing the sample into the plastic wells can be used in the present method. A preferred applicator is a disposable, single-use, plastic or wooden piece with a pointed end on one side. The end optionally has some bristles like bottle brush to increase the surface for collecting samples. A toothpick, for example, can be used to collect solid samples. The applicator is optionally sterile.

The volume of the non-liquid sample dispensed into each well is typically 20-50 μL, and is preferably 20-30 μL. The non-liquid sample is preferably dispensed into a well that can hold a volume of 200 μL.

### Methods for Collecting and Storing Applicator Samples

The present invention is also directed to a method for collecting and storing applicator samples compatible for high throughput automation. Applicator samples are usually environmental samples collected by applicators such as wipes, pads, swabs, paper tissues, sponge, etc. The applicators wipe on the surface of the environment that needs to be tested and are collected for testing.

The methods comprise the steps of: (a) providing a plate containing multiple wells, (b) wiping a surface with a first applicator, (c) dispensing the first applicator into a first well, and (d) repeating the steps (b)-(c) multiple times.

The present method optionally comprises steps of providing a box having a lid, placing the plate in the box during the steps (b)-(c), opening the lid during the dispensing step (c), and closing the lid during the collecting step (b).

The present method preferably comprises a step (e) after step (d) by placing an adhesive film on top of the plate and sealing the plate. The adhesive film is a film (such as plastic, aluminum, or paper) with an adhesive on one side. The adhesive adheres to the plate and the film serves as a top cover of the plate.

The steps (a)-(e) can be repeated multiple times with a new plate until all the samples are collected.

Plates suitable for the methods for collecting non-liquid samples are the same as those described for the liquid samples. The applicator is preferably dispensed into a well that can hold a volume of 2 mL.

### Devices

The present invention is also directed to a device for collecting and storing liquid samples compatible for high throughput automation. The device comprises: (a) a plate containing multiple wells, and (b) multiple rubber covers; wherein each rubber cover is (i) an integral part of the device, (ii) is on top of each well and individually seal each well, and (iii) has a pierceable area in the center of the cover.

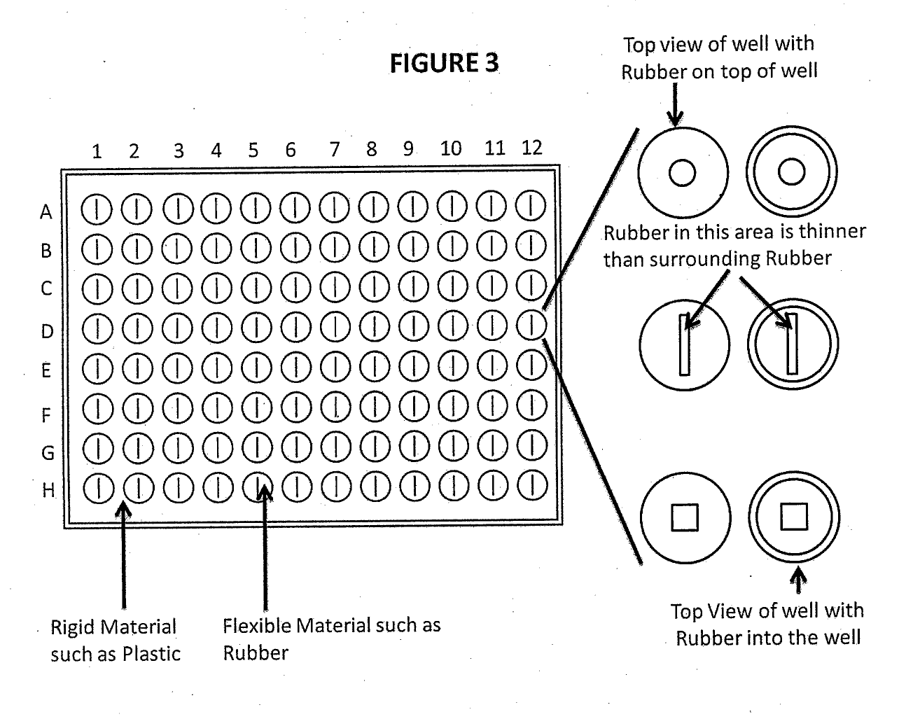

The device is a single piece made of two different materials, one being rigid plastic and the other being soft rubber material. The device can be made by injection molding and/or ultrasound welding. The rubber cover on top of each well can be indented into the well or it can be flat and above the well. Preferably, the rubber cover is individually on top of each cover with a plastic material in between the rubber covers. The seal has a pierceable area (a line, triangle, circle, or square) in the center of the well. The pierceable area is thinner than other areas of the rubber seal, and can be pierced easily. FIG. 3 illustrates the top view the device.

After puncture, the pierceable area is re-sealed due to the elastic nature of the rubber material. The rubber seal prevents any leakage of the liquid sample during the transportation of the samples to the laboratory for testing. The rubber seal also prevents any contamination due to aerosol in the field while collecting samples by not exposing the wells to the environment. In addition, the rubber seal prevents any cross contamination of samples between the wells while dispensing sample into a neighboring well.

The device optionally comprises a bottom plastic cover (e.g., a plastic plate) for the multi-well plate to sit on. The bottom cover serves as the cover for the bottom of the multiple wells such that the multi-well plate do not contact with an unclean surface and prevent the multi-well plate from carrying contamination. The bottom cover preferably snaps onto the multi-well plate during sample collection, storing, and transportation, and is removed (snapped out) for automation.

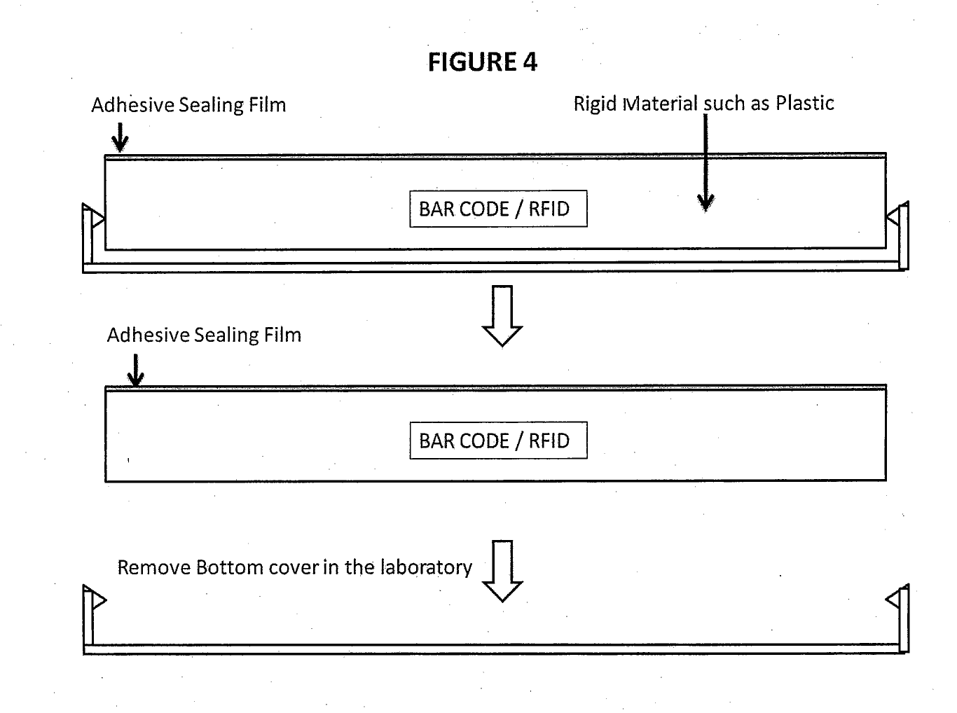

The device optionally comprises a bar code or a RF (radio frequency) ID for tracking purpose. FIG. 4 illustrates a side view of the device with bar code/RFID and bottom cover.

The features of the multi-well plates and the rubber materials are the same as those described above in Methods for Collecting Liquid Samples. Sample preparing such as nucleic acid extraction (DNA and RNA) is performed in the device once samples arrive in the testing laboratory. The device is compatible with automation conforming to SBS foot print.

The single-piece device of the present invention has several advantages over the two-piece device which contains a plate and a separate piece of a rubber cover. First, the single-piece device provides better sealing of the well, thus preventing leakage during shipment. Second, the two-piece device is not suitable for automation when using disposable plastic tips for preparing samples for testing. The rubber cover of the two-piece device does not stay steady and it interferes with the plastic tip pipetting; thus it has to be removed before sample preparation. In the one-piece device of the present invention, the rubber covers are an integral part of the device, and they do not interfere with pipetting through the rubber cover for sample preparing. The device of the present invention allows one to inject samples into the multi-wells, add reagents for sample preparation such as nucleic acid isolation, and retrieve the samples several times from the wells using an automated liquid handler, without the need to remove the cover, thus avoiding exposing the wells to the environment causing contamination and cross-contamination.

The present invention is further directed to a system for collecting and storing liquid samples compatible for high throughput automation. They system comprises: (a) the device of the present invention, (b) an adhesive film for sealing the plate after the wells are filled with samples, and (c) a tracking form for recording the identification of the samples.

The tracking form is used to communicate and track sample information and test results. The form has a tabular format and the tabular format is converted automatically into an array format by software for ease of tracking during sample collection. The device is bar-coded and the combination of plate ID and well ID is unique to a given sample.

The system optionally further comprises a hand held tracking device and software. The tracking device is used in the field to transmit the sample information to the testing laboratory using wireless internet or an electronic form. The hand held tracking device has the capability to scan the bar code of the collecting device (the multiple-well plate) and the barcode of the samples.

The present invention provides the following advantages over the current methods of collecting samples by tubes. There is no need to cap and de-cap the samples during sample collection or downstream processing. There is no need to transfer the samples from tubes into multi-well plates that are suitable for downstream automation. The present invention avoids sample contamination from the field and cross-contamination from the other samples. The present invention allows users to collect many samples in fewer steps and less time. User can easily track the samples using the plate bar code and well ID. The present invention provides methods and devices for collecting, storing, shipping, and tracking samples in an efficient, cost-effective, and accurate manner. The present invention is compatible for downstream automation when processing and analyzing the samples.

### Applications of the Devices and Methods

The samples collected by the methods and devices of the present invention are downstream processed in the laboratory for a variety of applications. DNA, RNA, and protein can be extracted from the samples by any means known to a skilled person (for example, see Tan et el.; J. Biomedicine and Biotechnology, Volume 2009, Article ID 574398).

The applications include, but are not limited to, nucleic acid based technologies such as transcription mediated amplification (TMA), nucleic acid sequence based amplification (NASBA), genotyping, sequencing, primer extension, PCR, Real-Time PCR, and nucleic acid labeling; immunoassays such as ELISA and RIA; mass spectroscopy analysis; chemical analysis such as detection of toxic compounds and metals (mercury and lead poisoning in aquatic animals); genetic tests in agriculture (plant specimens); process improvement screening tests in bio-processing; HIV screening in third-world countries; pathogen screening in blood banks (HIV, HCV, etc); pathogen testing in milk and dairy products; tissue typing organ donor screening (HLA typing); genetic data bases for forensics; new born screening; and environmental testing.

In the nucleic acid based application, once the liquid samples are received in the laboratory, they are logged in and a work order to process the sample is created. The samples are stored in the device in the refrigerator until they are ready for processing. The device is spun in a centrifuge to bring all the liquid to the bottom of the well. The adhesive film is removed and discarded. A nucleic acid extraction buffer (Epicenter) is then added to each well except the blank well using a robot in a single step with a multi-tip robotic head. The plates are sealed with clear adhesive plastic films and placed in a thermal cycler and incubated per manufacturer's recommendation.

Probe Master mix (Roche) containing necessary reagents such as Taq polymerase, dNTPS, salts and detergents is mixed with primers (IDT) and probes (ABI) to create the master mix for the assay. Appropriate amount of master mix is dispensed into each of the well in a Roche qPCR plate. Plastic seal from the sample plate is removed and sample is transferred to each well of the Roche qPCR plate. Appropriate assay control templates are added into the control wells. The Roche qPCR plate is sealed with an optically clear adhesive plastic seal and spun briefly. A PCR program is run for 45 cycles and the fluorescent data is collected at the end of each cycle and a Cp value is determined for each sample. Data are analyzed and reports are generated using the tracking forms submitted by the sample collectors while collecting the samples in the field.

The invention, and the manner and process of making and using it, are now described in such full, clear, concise and exact terms as to enable any person skilled in the art to which it pertains, to make and use the same. It is to be understood that the foregoing describes preferred embodiments of the present invention and that modifications may be made therein without departing from the scope of the present invention as set forth in the claims. To particularly point out and distinctly claim the subject matter regarded as invention, the following claims conclude this specification.

What is claimed is:

1. A method for collecting and storing liquid samples compatible for high throughput automation, comprising the steps of:
(a) providing a plate containing multiple wells, each of the multiple wells is top-sealed by a rubber material;
(b) collecting a first liquid sample into an applicator;
(c) piercing the applicator through the rubber material;
(d) dispensing the first liquid sample from the applicator into a first well; and
(e) repeating the steps (b)-(d) multiple times.

2. The method according to claim 1, further comprising a step (f) after step (e):
(t) placing an adhesive film on top of the plate and sealing the plate.

3. The method according to claim 1, further comprising a step of recording the identification of the samples in a tracking form.

4. The method according to claim 1, wherein the sample is dispensed when the plate temperature is between 0-8° C.

5. The method according to claim 1, wherein the plate contains 24, 48, 96, or 384 wells.

6. The method according to claim 1, wherein the sample volume is about 20-30 μL.

7. The method according to claim 1, wherein the rubber material is silicone rubber, bromo isobutylene isoprene, polybutadiene, polyisoprene, polyisobutylene, polyurethane, or halogenated butyl rubber.

8. The method according to claim 1, wherein the plate is made of polypropylene or polycarbonate.

9. A method for collecting and storing non-liquid samples compatible for high throughput automation, comprising the steps of:
(a) providing a plate containing multiple wells,
(b) collecting a first non-liquid sample with a first applicator,
(c) dispensing the first sample into a first well and discarding the first applicator, and
(d) repeating the steps (b)-(c) multiple times.

10. The method according to claim 9, further comprising a step (e) after step (d):
(e) placing an adhesive film on top of the plate and sealing the plate.

11. The method according to claim 9, further comprising:
providing a box having a lid,
placing the plate in the box during the steps (b)-(d),
opening the lid during the dispensing step (c), and
closing the lid during the collecting step (b).

12. A device comprising:
(a) a plate containing multiple wells, and (b) multiple rubber covers;
wherein each rubber cover is (i) an integral part of the device, (ii) is on top of each well and individually seal each well, and (iii) has a pierceable area in the center of the cover.

13. The device according to claim 12, wherein the rubber cover is indented into the well or is flat and above the well.

14. The device according to claim 12, wherein a plastic material in between the rubber covers.

15. The device according to claim 12, further comprising a bottom plastic cover snapped onto the plate.

16. The device according to claim 12, further comprising a bar code or a Radio Frequency ID for tracking purpose.

17. The device according to claim 12, wherein the rubber material is silicone rubber, bromo isobutylene isoprene, polybutadiene, polyisoprene, polyisobutylene, polyurethane, or halogenated butyl rubber.

18. A system for collecting and storing liquid samples compatible for high throughput automation, comprising:
(a) device according to claim 12,
(b) an adhesive film for sealing the plate after the wells are filled with samples, and
(c) a tracking form for recording the identification of the samples.

19. The system according to claim 18, further comprising a hand-held tracking device and software.
